(19) United States
(12) Patent Application Publication
(10) Pub. No.: US 2025/0164054 A1
(43) Pub. Date: May 22, 2025

(54) HIGH TEMPERATURE LINE HEATER

(71) Applicant: OBCORP, LLC, St. Louis, MO (US)

(72) Inventors: Aaron M. Allen, Godfrey, IL (US); Marcus C. McCarter, Catawissa, MO (US); Scott M. Ruben, St. Louis, MO (US)

(21) Appl. No.: 18/949,514

(22) Filed: Nov. 15, 2024

Related U.S. Application Data
(60) Provisional application No. 63/600,344, filed on Nov. 17, 2023.
(60) Provisional application No. 63/600,325, filed on Nov. 17, 2023.

(51) Int. Cl. F16L 53/38

(52) U.S. Cl. CPC F16L 53/38

(57) ABSTRACT

A stand-alone electric heater for preventing a high-temperature valve from freezing when a process line attached to the valve is not carrying a hot fluid. The heater includes a mineral insulated heating element formed into a generally rectangular loop, ends of which are carried in a threaded mounting block threaded into a junction box. Power is supplied to the heating element through a tracer in a tubing bundle from a power source at an end of the tubing bundle remote from the valve. The junction box also carries a thermostatic switch and a pilot light. The heating element is clamped to the valve by straps, and thermal insulation surrounds the heating element and the valve.

### CROSS-REFERENCE TO RELATED APPLICATIONS

Priority is claimed to U.S. Provisional Patent Application Ser. No. 63/600,325, filed Nov. 17, 2023, and U.S. Provisional Application Ser. No. 63/600,344, filed Nov. 17, 2023, both of which are hereby incorporated by reference.

### STATEMENT REGARDING FEDERALLY SPONSORED RESEARCH OR DEVELOPMENT

Not applicable.

### BACKGROUND OF THE INVENTION

Tubing bundles are widely used for carrying fluids through a variety of environmental conditions. Tubing bundles comprise one or more tubes packaged in a weatherproof jacket. When the tubing bundle is used in environments that may be colder than the desired operating temperature of the fluid, insulation is provided between the jacket and the tube(s), and a heating element, such as an electrical tracer or a steam tracer line, may also be provided adjacent the tube(s) within the jacket and insulation. Commercial tubing bundles are described, for example, in O'Brien/Ametek “TRACEPAK Tubing Bundle,” brochure QLT-TPBR, Ametek, Inc., 20 Sep. 2017, and in nvent/Raychem RTB Tubing Bundles Installation Guide, brochure Raychem-IM-H55626-RTBtubingbundle-EN-1805, nVent Services GmbH, 2018.”

Some applications of tubing bundles include impulse lines, sampling lines, and process lines. In some of these applications, one end of the tubing bundle terminates near a high temperature source, over 400° F. and sometimes as high as 1200° F. At these sustained temperatures, the commonly used end seals employed to seal the end of the tubing bundle are ineffective to protect the bundle, especially, but not exclusively, the electrical tracing element which is subject to damage at these temperatures.

A typical high temperature application is shown in FIG. 1, in which a process fluid, such as high-pressure steam, carried in a process line 30 is in fluid communication with an instrument 50 through a tubing bundle 70. In this illustrative application, the instrument 50 is a pressure transmitter 51, and the tubing bundle 70 includes one or more tubes 71 filled with liquid water. The tubing bundle includes an electrical tracer 73 designed to keep the tube(s) 71 in a narrow temperature band within a range of 50° F. to 250° F.

The transmitter 51 is typically mounted in an insulated container 53. The container 53 typically is connected to a power supply 55 which powers the instrument 51. The insulated container 53 frequently contains an electrical heating element 57 connected to the power supply 55 to protect the instrument 51 from freezing or to maintain an operating temperature for the instrument 51. A distal end of the tubing bundle 70 generally enters the insulated container 53 through a gland 59, and all fluid connections to the instrument 50 and electrical connections to the transmitter 51 and power supply 55 are made inside the insulated container 53. Inside the container 53, tube(s) 71 and tracer 73 are brought out of the tubing bundle 70 by cutting away and removing a jacket 75 and insulation 77. The exposed tube(s) 71 is/are connected to the transmitter 51 and optionally to other instruments within the container 53. The electric tracer 73 is connected to the power supply 55. These connections are well known in the art and do not in themselves form a part of the present invention.

The process line 30 is typically of large diameter, such as a two-foot diameter pipe, and the process fluid in the pipe is typically at a high temperature over 400° F., sometimes over 1000° F. A common application is in an electric power plant where the process line 30 carries high pressure steam at a temperature of around 1,000° F. to 1,200° F.

At a proximal end of the tubing bundle 70, tube(s) 71 and tracer 73, in the tubing bundle 70 are brought out of the tubing bundle 70 by cutting away and removing the jacket 75 and insulation 77. The exposed tube(s) 71 is/are connected to the process line 30 through valves 31 and 33 in series. The electric tracer 73 would be damaged by sustained contact with the valves 31 and 33 or any other surface over about 350° F. It therefore is terminated in accordance with local codes, such as by looping it back and capping it in a junction box 79 attached to the tubing bundle 70.

Because of the high temperature of the fluid (steam) flowing through the tubes, a simple silicone seal or heat shrink boot cannot be used for protecting the cut proximal end of the tubing bundle 70. Instead, to protect the exposed proximal end of the tubing bundle 70 and to meet local codes, the open end of the tubing bundle 70 is closed with a high temperature end seal kit 80.

A current state-of-the-art end seal kit 80 includes a cast cup 81 having fittings in its closed end for tube(s) 71 and/or tracer 73. Detailed installation procedures for one such end seal kit are set out in “High Temperature End Seal Kit Selection Grid and Installation Instructions,” brochure QLT-HIGHTEMP-INST 2N, Ametek, Inc, 16 Sep. 2014. Instructions for a similar end seal kit are given in “FAK-7HTS High Temperature Tubing Bundle End Seal Kit-INSTALLATION PROCEDURES”, Thermon, San Marcos, Texas.

There are at least two problems with current constructions of the connection between the proximal end of the tubing bundle 700 and the process line 300.

First, the end seal kit 80 must be made to accommodate the diameter of the tubing bundle, the number of tubes within the bundle, and the number of tracers, if any. This requires a large inventory of cups 801. Further, installing the cup requires carefully sealing the open end of the cup to the outer surface of the tubing bundle, either by wrapping tape around them or by stuffing the gap between the cup and the tubing bundle, or both. Moreover, feeding the tubes 701 and tracer 703 through the fittings on the cup 801 is tedious at best and may result in damage to the tubes or tracer. The skill and care required of the installer make installation time-consuming and unreliable.

A solution to this problem is found in a copending application, in the name of Aaron Allen, one of the present inventors, filed contemporaneously with the present application and commonly assigned with the present application. That application is identified as attorney docket number OBC H007U1 and is hereby incorporated by reference. In accordance with an illustrative embodiment of that invention, an end seal for a tubing bundle includes a canister having an opening at a first end for the tubing bundle, a cover for the second end, the cover carrying a heat-shrinkable sleeve that surrounds the tubing bundle and is shrinkable to form a water-tight fit with the tubing bundle, and a lid at a second end of the canister, the lid having at least one tube fitting sized to form a seal with a tube carried by the tubing bundle.

The second problem is that the valves 31 and 33, and the tubes 71 attached to them are normally subjected to high temperatures, typically between 1000° F. and 1200° F. when the valves 31 and 33 are open. However, when the valves 31 and 33 are closed, as for servicing the steam line 30 or a steam turbine attached to the steam line 30, the valves and tubes are subject to ambient temperatures and may freeze. Freezing may damage the valves, the piping to and from the valves, or the tubing attached to the valves. Even if no damage is done, the process of thawing the valves and surrounding pipes must be done carefully and may take hours to complete. The present invention is directed to this second problem.

### BRIEF SUMMARY

In accordance with an embodiment of the present invention, a stand-alone electric heater is provided for preventing a high-temperature valve from freezing when a process line attached to the valve is not carrying a hot fluid. In an embodiment, the heater comprises a junction box, a heating element which is resistant to high heat and is formed into a loop shaped and sized to form a heat-conducting engagement with a valve, ends of the heating element being carried in a mounting block mounted in a first opening in the junction box. In an embodiment, the mounting block is threaded into the first opening in the junction box. In an embodiment, a second opening in the junction box is adapted to receive a power source. In an embodiment; the heater includes a temperature-sensitive switch, the switch closing when exposed to temperatures near or below freezing. In an embodiment; the temperature switch is housed in a structure threaded into an opening in the junction box. In an embodiment, the heater comprises a pilot light. In an embodiment, the pilot light is housed in a structure threaded into an opening in the junction box. In an embodiment, the heating element and pilot light are wired inside the junction box to be activated by the power source when, and only when, the temperature switch is closed. In an embodiment, the electric heater comprises clamps adapted to clamp the heating element to a high temperature valve. To prevent excessive power surges, in an embodiment the heating element draws no more than three hundred watts at any expected line voltage. In embodiments, the mineral-insulated heating element is rated at no more than three hundred watts at any expected line voltage.

In embodiments, a system comprises a process line carrying a hot fluid having a temperature in excess of 400° F., an instrument remote from the process line, a tubing bundle comprising at least one tube and at least one electrical tracer surrounded by a jacket, a distal end of the tubing bundle being connected to the instrument and a proximal end of the tubing bundle being connected to the process line through at least one valve, and a heater attached to the valve to protect the valve from freezing when the process line is not carrying the hot fluid, the heater being powered by an electrical power source at the distal end of the tubing bundle. In embodiments, the electric tracer comprises two wires separated by a resistance material, the power source is connected to the electric tracer at the distal end of the tubing bundle, and the heater is connected to the tracer at the proximal end of the tubing bundle. In embodiments, the heater draws insufficient power to damage the tracer. In embodiments, the heater consumes no more than three hundred watts. In embodiments, the heater consumes no more than one hundred watts. In embodiments, the heater comprises a mineral-insulated heating element. In embodiments, the heater comprises a junction box and a mineral insulated heating element formed to heat the valve, ends of the heating element being carried in a threaded mounting block, the threaded mounting block being threaded into the junction box. An insulated electrical conductor extends into the junction box where it is connected to the heating element. In embodiments, a temperature-sensitive switch controls activation of the heating element, the switch closing when exposed to temperatures near or below freezing. In embodiments, the temperature sensitive switch is housed in a structure threaded into the junction box. In embodiments, a pilot light is threaded into the junction box and is activated when the heating element is activated. In embodiments, thermal insulation surrounds at least a part of the heating element and at least a part of the valve.

In embodiments, a piping element subject to freezing when flow of a fluid through the piping element is cut off is protected by an electric heater comprising a heating element formed into a loop shaped to engage the piping element, the heating element withstanding high temperatures above 500° F.; a connector attaching the heating element in heat transfer relationship to the piping element, and thermal insulation surrounding at least a part of the piping element and at least a part of the heating element. In embodiments, the heating element is a mineral-insulated self-supporting rod. In embodiments, the connector comprises a strap extending around the piping element and the heating element.

Various combinations of the foregoing elements are contemplated as a part of the present invention.

### BRIEF DESCRIPTION OF THE SEVERAL VIEWS OF THE DRAWINGS

FIG. 1 is a view in front perspective of a known high temperature application in which the present invention is useful.

FIG. 2 is a detail view in perspective, corresponding to FIG. A, of two high temperature line heaters in accordance with an embodiment of the present invention, applied to the system shown in FIG. 1.

FIG. 3 is a view in perspective, corresponding to FIG. 2, of the heaters of FIG. 2.

FIG. 4 is a view in rear elevation of the heaters of FIG. 3

FIG. 5 is a view in top plan of the heaters of FIGS. 3 and 4.

FIG. 6 is a wiring diagram for the heaters of FIGS. 2-5.

FIG. 7 is a view in perspective of another embodiment of heating element of the line heater of the present invention.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

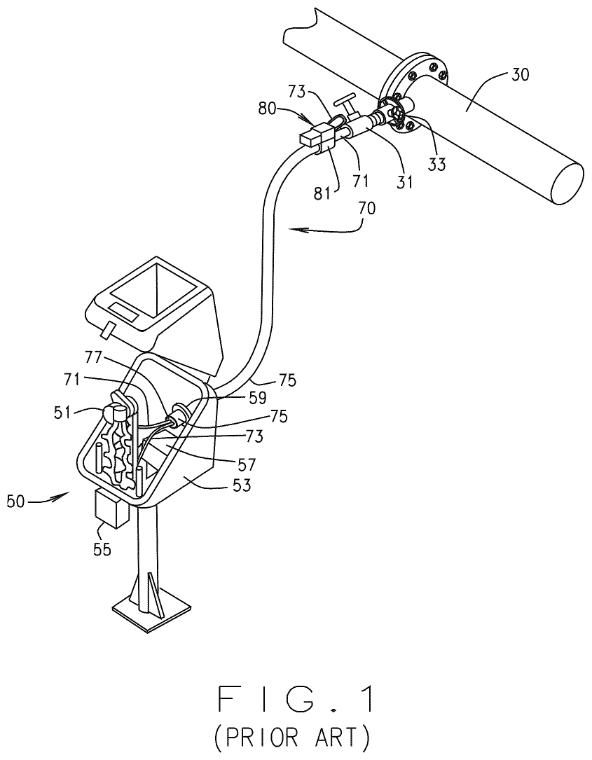

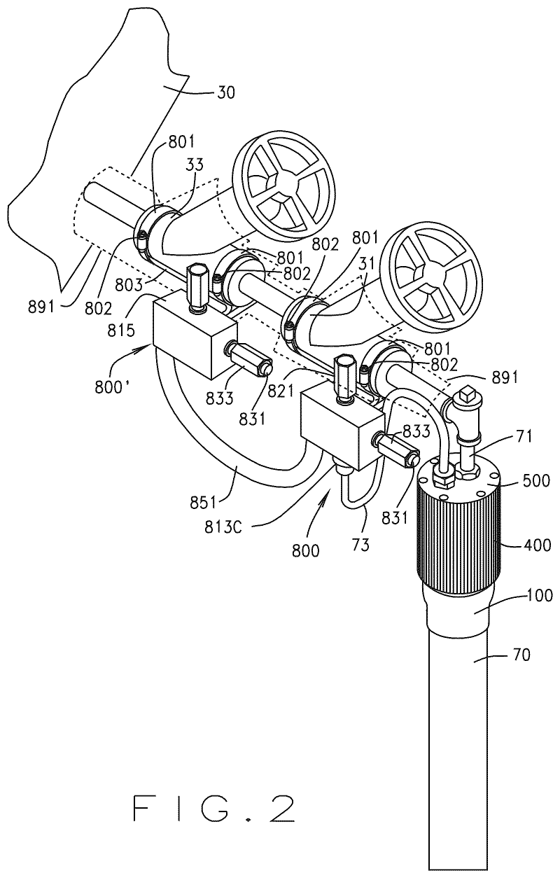

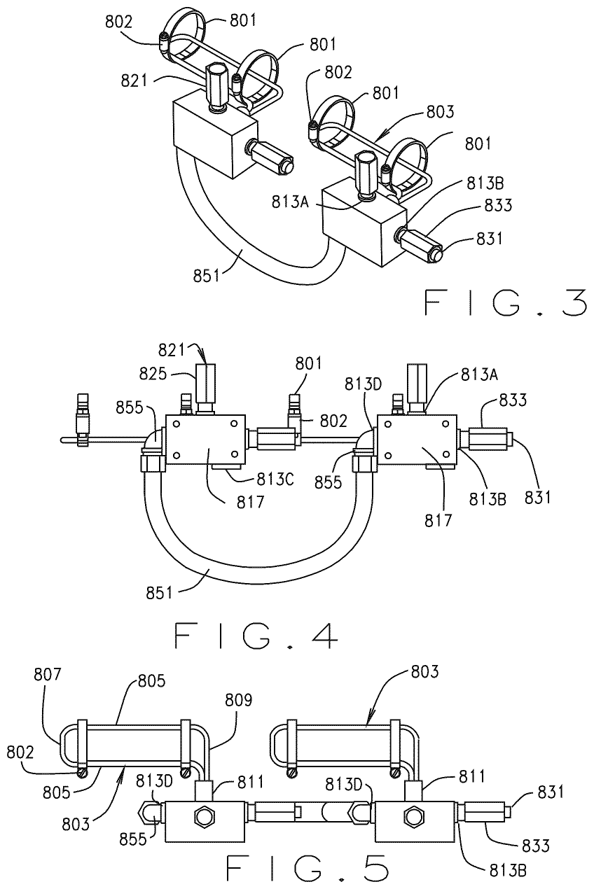

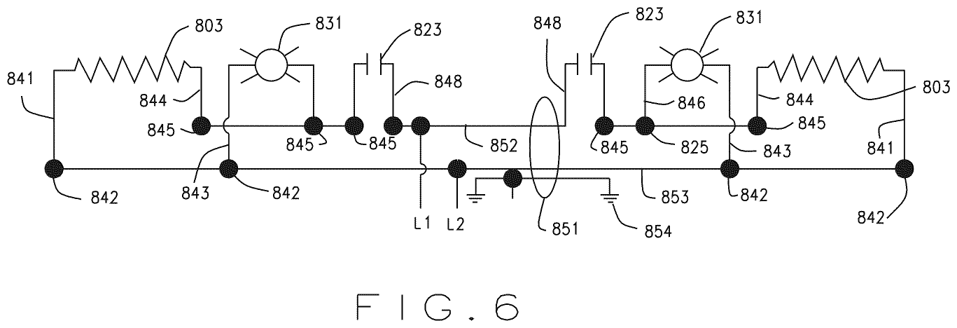

An illustrative embodiment of high temperature heater of the invention is shown in FIGS. 2-6. As shown in FIG. 2, illustrative high temperature line heaters 800 and 800′ of the present invention are shown attached to valves 31 and 33, respectively, of FIG. 1 by stainless steel band clamps (hose clamps) 801. The structures of the heaters 800 and 800′ are substantially identical; they will hereinafter generally be described simply with respect to one heater 800. The clamps 801 are openable to allow their bands to wrap around the valves 30 and 31 and are tightened with a worm gear 802. Illustratively, the clamps 801 have a clamping diameter of from three inches to six inches, making them adaptable to most high temperature valves.

The clamps 801 hold rigid, generally rectangular mineral-filled resistance heating elements 803 in heat transfer relationship against the bottoms of the bodies of valves 31 and 33. The heating elements 803 each draw 100 W. Each heating element 803 is illustratively a self-supporting metal tube having an internal heating element insulated from the tube by a mineral such as magnesium oxide. The metal tube is illustratively made from an alloy, such as Inconel® nickel chromium alloy, which maintains its strength at temperatures of 1200° F. The heating element 803 is formed into a generally rectangular shape, having a length somewhat greater than the length of the body of valves 31 and 33 and a width less than the diameter of the body of valves 31, with ends 807 and 809 of the heating element extending beyond the valve body. At a corner of the heating element 803, free ends 810 of the heating element are brought out parallel to each other and extend into a cylindrical mounting block 811. The mounting block 811 is externally threaded and is sized to thread into a central threaded opening 813 in a broad wall of a junction box 815, forming a watertight fit.

Central threaded openings 813A, 813B, 813C, and 813D are also provided in the top, distal, bottom, and proximal side walls, respectively, of the junction box 815. A gasketed lid 817 covers the other broad side of the junction box 815,

A thermostat 821 is threaded into opening 813A in an upper wall of each of the junction boxes 815. The thermostat 821 is illustratively a snap-action thermal switch 823 with a set point of 50° F.+/−5°. It will be understood that other thermostatic switches may be used, such as a bulb and capillary, a resistance temperature detector (RTD) or an electronic sensor type. The thermal switch 823 is illustratively mounted in a sealed metal hexagonal prism 825, one end of which is threaded into an adapter sized to thread into the opening 813. The thermostats 821 independently sense temperature in ambient air around each valve.

An LED pilot light 831, mounted in the end of a similar metal hexagonal prism 833, is threaded into opening 813B in the distal end wall of each of the junction boxes 815. As shown in FIG. 2, the pilot lights 831 face away from the process line 30 and are thus visible from any vantage point that can see the valves 31 and 33.

As shown in FIG. 6, one lead 841 from the heating element 803 is connected at wire connector 842 to a lead 843 of the pilot light 831. A second lead 844 of the heating element 803 is connected at wire connector 845 to a second lead 846 of the pilot light 831 and to one lead 847 of the thermal switch 823.

As thus far described, the heaters 800 and 800′ of this illustrative embodiment are identical.

As shown in FIGS. 2-5, a wire cable 851 extends from a water-tight fitting 853 mounted in the proximal opening 813D of the distal junction box 817 to a water-tight fitting 855 mounted in the distal opening 813D of the proximal junction box 817. The wire cable 851 carries wires 852, 853 and 854. Wire 852 is connected at each end to leads 848 in the respective junction boxes 817. Wire 853 is connected at each end to wire connectors 842 in the respective junction boxes 817. Wire 854 is connected to ground in each junction box 817. The wire cable 851 may be installed during installation of the heaters 800 and 800′, or, preferably, it is factory-installed.

Installation of the heaters 800 and 800′ requires merely that the heating elements 803 be placed in contact with the valves 31 and 33 with their ends 807 and 809 extending slightly beyond their respective valves 31 and 33. Their clamps 801 are placed around the heating elements 803 and valves 31 and 33 and tightened to secure the heating elements 803, hence the heaters 800 and 800′.

Tracer 73 of the tubing bundle 70 is taken out from a high-temperature termination 10, rather than terminating the tracer 73. The high temperature termination 10 is preferably made in accordance with co-filed application, attorney docket number OBC H007, entitled “Tubing Bundle End Seal,” incorporated herein by reference. Briefly, the high temperature termination 10 includes an extruded canister 400 having affixed to its distal end a fitting 300 carrying a tube 100 which is heat-shrunk to the tubing bundle 70. At its proximal end, the canister 400, a plate 500 is held by screws to the canister 400. Fittings 600 are threaded into the plate 500, forming water-tight passages for the tube 71 and tracer 73 of tubing bundle 70.

As shown in FIGS. 2 and 6, the two wires L1 and L2 of the tracer 73 are brought through a water-tight fitting into the opening 813C in the lower wall of the junction box 815 of distal heater 800. Wire L1 is connected to a second lead 848 of the thermal switch 823. Wire L2 is connected at 842 to leads 841 and 843.

Preferably, the valves 31 and 33 and their heating elements 803 are covered with insulation, as indicated at 891.

In operation, as long as the process line 30 is carrying steam, the ambient temperature sensed by the thermostats 823 is above the set point of the thermostats, and the heaters 800 and 800′ remain unpowered. When the line 30 is deactivated and ambient temperature around the thermostats 823 falls below their set points, the thermostats 823 close, the heating elements 803 are powered from the remote power source 55 and tracer 73, and the pilot lights 831 are lit to allow workers remote from the heaters to ascertain that the heaters are powered on. The heaters 800 and 800′ provide sufficient heat to the valves 31 and 33 to prevent the water in them and in their associated piping from freezing, but they do not draw enough power to harm the tracer 73.

If the distance between the power source 55 and the heaters 800 and 800′ is too great, the power drop across the tracer 73 may be too great to power the heating elements 803. In this case, a separate electric wire will need to be run to between the power source 55 and the heaters 800 and 800′, either internal of the tubing bundle 70 or external to it.

If only a single valve needs to be protected from freezing, the only change that needs to be made in the single required line heater 800 is the elimination of the cable bundle 851. The opening 813D is closed with a watertight screw plug. If more than two valves need to be protected from freezing, additional line heaters may be daisy-chained using additional cable bundles 851 from junction box to junction box. It is believed that four line heaters can be supported.

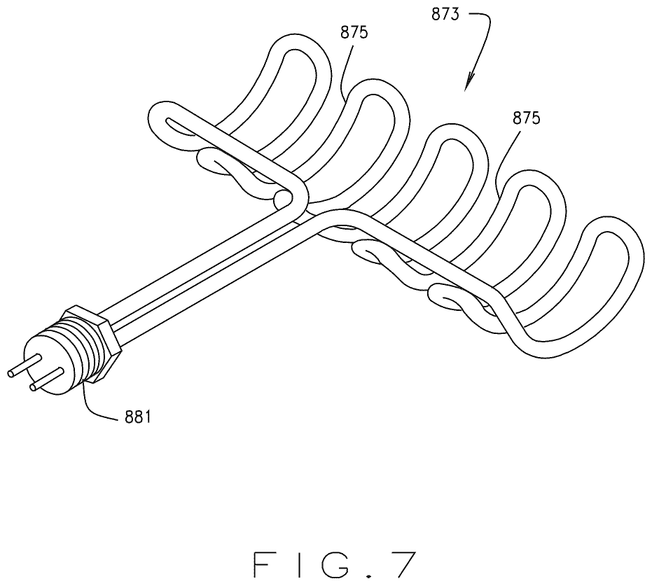

A second embodiment of a heating element 873, which may be substituted for the heating element 803, is shown in FIG. 7. Like the heating element 803, the heating element 873 is a tube formed as a generally rectangular loop with its ends held in an externally threaded mounting block 881. In this embodiment, however, one side of the loop is serpentine or sinuous, rather than straight, and the reaches 875 of the sinuous side are concave, to embrace the lower side of the valve 31 or 33. In this embodiment, the heating element 873 is mineral-filled, but its casing is stiff and sufficiently flexible to permit the concave reaches to be manually formed around the valve 31 and 33 in heat-transfer engagement with the valve 31 or 33. When held by straps 801 to the valve 31 or 33, the heating element 873 is sufficiently rigid to support the junction box 815.

Numerous variations, within the scope of the appended claims, will occur to those skilled in the art.

Merely by way of example, the fittings in the junction boxes 815 may be in any of the walls of the junction boxes, including their covers. The thermostat 821 may be mounted anywhere on or in one or both junction boxes 815. The thermostat 821 may be located in a position remote from the junction boxes, inside or outside the insulation surrounding the valves 31 and/or 33. The pilot lights 831 may be configured differently or omitted.

All patents, patent applications, and literature mentioned herein are hereby incorporated by reference.

1. A stand-alone electric heater for preventing a high-temperature valve from freezing when a process line attached to the valve is not carrying a hot fluid, the heater comprising
a junction box;
a self-supporting elongate heating element formed into a loop shaped and sized to form a heat-conducting engagement with the high-temperature valve, ends of the heating element being carried in a mounting block, the mounting block being mounted in a first opening in the junction box, the heating element withstanding high temperatures above 500° F.;
at least one clamp, the clamp being sized and constructed to attach the heating element to the valve;
a second opening in the junction box adapted to receive a power source; and
a temperature-sensitive switch connected electrically between the power source and the heating element, the switch closing when exposed to temperatures near or below freezing, thereby connecting the heating element to the power source to activate the heating element;
the heating element, the mounting block, and the at least one clamp being sized and constructed to support the junction box from the valve.

2. The stand-alone electric heater of claim 1 wherein the mounting block is threaded into the first opening in the junction box.

3. The stand-alone electric heater of claim 1 wherein the temperature-sensitive switch is housed in a structure threaded into an opening in the junction box.

4. The stand-alone electric heater of claim 1 further comprising a pilot light housed in a structure threaded into an opening in the junction box, the heating element and pilot light being wired inside the junction box to be activated by the power source when, and only when, the temperature switch is closed.

5. In a system comprising a process line carrying a hot fluid having a temperature in excess of 400° F., an instrument remote from the process line, a tubing bundle comprising at least one tube and at least one electrical tracer surrounded by a jacket, a distal end of the tubing bundle being connected to the instrument and a proximal end of the tubing bundle being connected to the process line through at least one valve, the improvement comprising a heater attached to the valve to protect the valve from freezing when the process line is not carrying the hot fluid, the heater being powered by an electrical power source at the distal end of the tubing bundle.

6. The improvement of claim 5 wherein the electric tracer comprises two wires separated by a resistance material, wherein the power source is connected to the electric tracer at the distal end of the tubing bundle, and wherein the heater is connected to the tracer at the proximal end of the tubing bundle.

7. The improvement of claim 5 wherein the heater comprises a mineral-insulated heating element, the heater having sufficient flexibility to be formed around the high-temperature valve.

8. The improvement of claim 5 wherein the heater consumes no more than three hundred watts at expected line voltages.

9. The improvement of claim 8 wherein the heater consumes no more than one hundred watts.

10. The improvement of claim 9 wherein the heater comprises a junction box and a mineral insulated heating element formed to heat the valve, ends of the heating element being carried in a threaded mounting block, the threaded mounting block being threaded into a first opening in the junction box, an insulated electrical conductor extending through a second opening in the junction box.

11. The improvement of claim 10 further comprising a temperature-sensitive switch, the switch closing when exposed to temperatures near or below freezing, the temperature switch being housed in a structure threaded into a third opening in the junction box and being wired to connect the power source to the heating element when and only when the switch is closed.

12. The improvement of claim 11 further including a pilot light, the pilot light being housed in a structure threaded into a fourth opening in the junction box, the pilot light being wired inside the junction box to be activated by the power source when and only when the temperature switch is closed.

13. The improvement of claim 9 further comprising thermal insulation surrounding at least a part of the heating element and at least a part of the valve.

14. The improvement of claim 5 further comprising a strap extending around the valve and the heating element, the strap holding the heating element in thermal contact with the valve.

15. In combination,
a piping element subject to freezing when flow of a fluid through the piping element is cut off;
an electric heater adapted to prevent the piping element from freezing, high-temperature valve from freezing when a process line attached to the valve is not carrying a hot fluid, the heater comprising
a junction box having an opening in each of at least two sides thereof;
a heating element formed into a generally rectangular loop, ends of the heating element being carried in a threaded mounting block, the threaded mounting block being threaded into a first opening in the junction box, the heating element withstanding high temperatures above 500° F.; and
a power line extending through a second opening in the junction box, the power line being connected to the heating element inside the junction box; and
a connector attaching the heating element in heat transfer relationship to the piping element.

16. The combination of claim 15 further comprising thermal insulation surrounding the piping element and the heating element.

17. The combination of claim 15 wherein the connector comprises a strap extending around the piping element and the heating element.

18. A system comprising a process line carrying a hot fluid having a temperature in excess of 400° F., an instrument remote from the process line, a tubing bundle comprising at least one tube and at least one electrical tracer surrounded by a jacket, a distal end of the tubing bundle being connected to the instrument and a proximal end of the tubing bundle being connected to the process line through at least one valve, and a heater attached to the valve to protect the valve from freezing when the process line is not carrying the hot fluid, the heater being powered by an electrical power source at the distal end of the tubing bundle.

19. The system of claim 18 wherein the electric tracer comprises two wires separated by a resistance material, the power source is connected to the electric tracer at the distal end of the tubing bundle, and the heater is connected to the tracer at the proximal end of the tubing bundle.

20. The system of claim 19 wherein the heater comprises a junction box and a mineral insulated heating element formed and positioned to heat the valve, ends of the heating element being carried in a threaded mounting block, the threaded mounting block being threaded into the junction box.
